(19) United States
(12) Patent Application Publication
(10) Pub. No.: US 2025/0311000 A1
(43) Pub. Date: Oct. 2, 2025

(54) OVERHEAD MANAGEMENT FOR WIRELESS CLIENTS WITH PERIODIC IN-DEVICE COEXISTENCE CHALLENGES AND PRIVACY CONCERNS

(71) Applicant: Cisco Technology, Inc., San Jose, CA (US)

(72) Inventors: Brian D. HART, Sunnyvale, CA (US); Binita GUPTA, San Diego, CA (US); Malcolm M. SMITH, Richardson, TX (US)

(21) Appl. No.: 19/093,063

(22) Filed: Mar. 27, 2025

Related U.S. Application Data
(60) Provisional application No. 63/571,375, filed on Mar. 28, 2024.
(60) Provisional application No. 63/760,547, filed on Feb. 19, 2025.

(51) Int. Cl. H04W 74/0816; H04L 5/00; H04W 74/08

(52) U.S. Cl. CPC H04W 74/0816; H04L 5/0053; H04W 74/0866

(57) ABSTRACT

Techniques for improving in-device coexistence through periodic unavailability prediction. The techniques include receiving a plurality of unavailability signals from a wireless device. The techniques further include generating a list of data points based on the plurality of unavailability signals. The techniques further include predicting a periodicity pattern from the list. The techniques further include providing a frame comprising details associated with the periodicity pattern to the wireless device.

### CROSS-REFERENCE TO RELATED APPLICATIONS

This application claims benefit of co-pending U.S. provisional patent application Ser. No. 63/760,547 filed Feb. 19, 2025, and co-pending U.S. provisional patent application Ser. No. 63/571,375 filed Mar. 28, 2024. The aforementioned related patent applications are herein incorporated by reference in their entirety.

### TECHNICAL FIELD

Embodiments presented in this disclosure generally relate to wireless communications. More specifically, embodiments disclosed herein relate to improving in-device coexistence through periodic unavailability prediction.

### BACKGROUND

Devices, such as mobile phones, tablets, laptop computers, etc., are becoming increasingly more capable, integrated with a variety of functions which may include Bluetooth, Wi-Fi, and LTE capabilities, among others. So as to limit interference between these functions within a device (i.e., when a device may transmit via Bluetooth and Wi-Fi), the device may report an in-device coexistence (IDC) “absences” (e.g., periods when the device is unavailable to receive transmissions) to an access point (AP), such as a router. The device's unavailability windows might be periodic, semi-random, or a combination thereof. In some cases, however, a device may have reduced capability and/or consider the access point a privacy attacker and, as a result, the device may not report a regular sequence of IDC absences to the access point (e.g., in a single message). Instead, the device may report the start (and/or the end) time of each unavailability window individually. In some cases, the device might not be able to transmit a message before the start of the unavailability window. This results in unnecessary, redundant, and wasted wireless transmissions since the access point may try, repeatedly, to send transmissions to the device, which can cause congestion, interference, and a diminished user experience. Even when the message is sent, it is only for one unavailability window (i.e., rather than a regular sequence of IDC absences corresponding to a number of unavailability windows). This also results in undue congestion as the device must report each time an upcoming absence starts (and, in some cases, when it ends).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example device with Bluetooth, ultra-wideband (UWB), and Wi-Fi coexistence, according to some embodiments of the present disclosure.

FIG. 2 depicts an example station (STA) reporting an IDC unavailability frame to an associated AP, according to some embodiments of the present disclosure.

FIG. 3 depicts an example AP providing a predicted IDC unavailability pattern to a connected STA, according to some embodiments of the present disclosure.

FIG. 4 depicts an example channel usage request frame, according to some embodiments of the present disclosure.

FIG. 5 depicts an example interaction in which the associated AP provides the predicted IDC unavailability pattern based on IDC unavailability frames associated with the connected STA, according to some embodiments of the present disclosure.

FIG. 6 depicts an example method for the associated AP to predict the IDC unavailability pattern and provide it to the connected STA, according to some embodiments of the present disclosure.

FIG. 7 depicts an example method for the associated AP to provide a teardown frame and/or perform remedial action with respect to the predicted IDC unavailability pattern based on one or more responses from the connected STA, according to some embodiments of the present disclosure.

FIG. 8 is a flow diagram depicting an example method for IDC unavailability prediction, according to some embodiments of the present disclosure.

FIG. 9 depicts an example network device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

Embodiments described herein include a method. The method includes receiving a plurality of unavailability signals from a wireless device. The method further includes generating a list of data points based on the plurality of unavailability signals. The method further includes predicting a periodicity pattern from the list. The method further includes providing a frame comprising details associated with the periodicity pattern to the wireless device.

Embodiments further include an access point, including one or more processors and one or more memories storing a program, which, when executed on any combination of the one or more processors, performs operations. The operations include receiving a plurality of unavailability signals from a wireless device. The operations further include generating a list of data points based on the plurality of unavailability signals. The operations further include predicting a periodicity pattern from the list. The operations further include providing a frame comprising details associated with the periodicity pattern to the wireless device.

Embodiments further include a non-transitory computer-readable medium containing computer program code that, when executed by operation of one or more computer processors, performs operations. The operations include receiving a plurality of unavailability signals from a wireless device. The operations further include generating a list of data points based on the plurality of unavailability signals. The operations further include predicting a periodicity pattern from the list. The operations further include providing a frame comprising details associated with the periodicity pattern to the wireless device.

### Example Embodiments

Aspects of the present disclosure provide apparatuses, methods, processing systems, and computer-readable mediums for improving IDC through periodic unavailability prediction.

Nowadays, many wireless client devices, like smartphones, often integrate multiple communication technologies, such as Bluetooth, Wi-Fi, and UWB, within a single device. Multiple radios operating simultaneously in overlapping or adjacent frequency bands, however, may lead to interference and resource contention. To mitigate these issues and improve performance across multiple services, devices may report one or more IDC absences to an AP (e.g., to inform the AP that the device is unavailable for wireless transmissions due to having to allocate hardware resources to another wireless technology). Currently though, some devices may not report ongoing periodic IDC absences to an AP (e.g., if the device is low-capability and/or considers the AP to be a privacy attacker) and may only report IDC absences one at a time (i.e., rather than a regular sequence of IDC absences in a single message). In some cases, the device may not report its unavailability at all. Both scenarios result in unnecessary, redundant, and wasted wireless transmissions (e.g. due to the device sending one frame for every unavailability window and/or the AP repeatedly attempting to send transmissions to the device) which can cause congestion, interference, and a diminished user experience.

To improve wireless traffic management, techniques described herein reduce redundant and obstructive wireless traffic by implementing an AP to record IDC absences when provided from a device to the AP, generate a list of data from those IDC absences, predict a periodicity pattern from the list of data, and send the predicted periodicity pattern to the device (e.g., if a confidence score associated with the pattern exceeds a threshold value) for confirmation.

For example, an AP may receive a plurality of unavailability signals from a wireless client device, such as a smartphone. The plurality of unavailability signals may be unsolicited IDC frames such as those a device may report one at a time when it begins and/or ends a window of unavailability. A list of data points may be generated from the plurality of unavailability signals, where the data points may correspond to a time at which the window of unavailability is to begin and/or a time at which the window of unavailability is to end. If, after generating the list, the data is sparse (e.g., there is insufficient data to accurately predict a periodic pattern from that data), the AP may wait for a period of time to receive more data and/or send a burst of long transmission opportunities (TXOPs) to the client device to acquire more data. Using an algorithm, the AP may predict, from the list of data points, a periodicity pattern (i.e., a regular sequence) of when the client device will be unavailable. During the prediction process, the AP may use supplemental information to increase the accuracy and efficiency of the predicted unavailability sequence. The supplemental information may include types of transmissions and/or protocols, as well as patterns associated with the particular type of transmission and/or protocol. For example, if a Bluetooth signature is detected (e.g., using a spectrum analysis tool), the AP may apply timing patterns associated with Bluetooth (e.g., an unavailability sequence for Bluetooth may differ from an unavailability sequence for Wi-Fi) when making the prediction.

Once the periodicity pattern is predicted, the AP may determine whether the prediction meets or exceeds a confidence level (e.g., generating a confidence score for that prediction and comparing it to a threshold value). The confidence score, for instance, may be based on known interferers, particular frequencies, IDC types, and/or the like. If the confidence score is not met, the AP may repeat one or more of the foregoing steps to create a new prediction that meets or exceeds the confidence level. Once the confidence level is met or exceeded, the AP may send a frame, such as a channel usage request frame, to the client device. The channel usage request frame may contain, among other elements, a target wake time (TWT) element to indicate the timing of the predicted unavailability sequence. In this way, the client device does not have to send compute-intensive or privacy-related information to the AP, nor does it have to send unsolicited IDC frames to the AP, thereby reducing the wireless congestion (e.g., reducing overhead).

After the AP sends the channel usage request frame to the client device, the client device may take no action, may acknowledge the channel usage request frame, such as by sending a response or operating consistent with the predicted unavailability sequence (in both cases, the AP may operate using the predicted unavailability sequence), or may indicate that the predicted unavailability sequence is incorrect (e.g., by sending a response and/or by operating contradictory to the predicted sequence). In the last case, the AP may generate a new prediction according to one or more of the foregoing steps and send an updated request frame to the client device (or abandon the effort if no updated prediction reaches a minimum confidence level). Finally, once the predicted session ends, either the client device or the AP may send a teardown frame to terminate the agreement.

In sections of this present disclosure, device, client device, and wireless client device may be used interchangeably and may also be referred to as a non-AP station (STA).

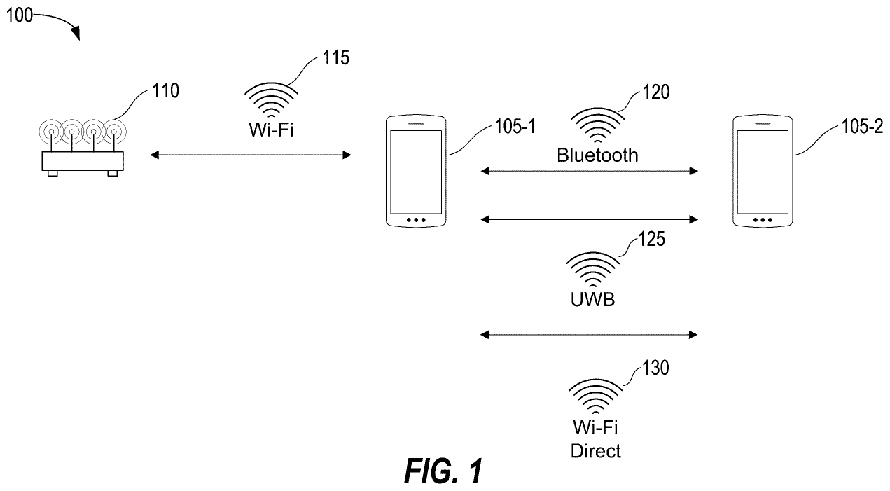

FIG. 1 depicts an example device 105-1 with Bluetooth, UWB, and Wi-Fi coexistence, according to some embodiments of the present disclosure.

As depicted, STA 105-1 connects to AP 110 as a client in a basic service set (BSS). Through this wireless connection 115 (e.g., a Wi-Fi connection), STA 105-2 gains access to the broader network infrastructure (e.g., Internet). In one embodiment, the AP 110 manages the communication between STA 105-1 and other devices on the network and coordinates transmission timing and resource allocation.

As depicted, STA 105-1 also maintains direct connections with peer STA 105-2 using Bluetooth 120, UWB 125, and Wi-Fi Direct 130. The Bluetooth connections 120 between STA 150-1 and STA 105-2 enable low-power, short-range data exchange, such as audio streaming, peripheral device pairing, or file transfers. The UWB connections 125 allow high-precision spatial awareness and data synchronization, which may be used for indoor positioning, secure keyless access, or high-speed data transfer between the two devices 105-1 and 105-2. The Wi-Fi Direct 130 facilitates high-speed and medium-range data transfer, such as sharing large files or streaming high-quality media between devices.

In this figure, STA 105-1 is depicted as a mobile phone, which is provided for conceptual clarity. In some embodiments, STA 105-1 may be any other wireless communication device, such as a laptop, tablet, smartwatch, or any other portable or stationary device configured with multiple wireless communication technologies.

The depicted wireless technologies, including infrastructure connections 115, Bluetooth 120, UWB 125, and Wi-Fi Direct 130, are provided as examples for conceptual clarity, and can include a subset of these wireless protocols, or additional wireless protocols. In some embodiments, STA 105-1 may support additional wireless communication interfaces, including Wi-Fi for off-channel docking (used for wireless display mirroring, data transfer, or peripheral connections to a docking station) or Near Field Communication (NFC) (for short-range authentication and data exchange). In some embodiments, STA 105-1 may utilize a multi-link operation (MLO) setup, where the device 105-1 maintains simultaneous connections to AP 110 over multiple channels or frequency bands. For example, the STA 105-1 may establish three concurrent links with AP 110, including one link on the 2.4 GHz band (for longer range and lower power consumption), one link on the 5 GHz band (for higher throughput and reduced interference), and one link on 6 GHz band (for ultra-fast and low-latency communication). In some embodiments, the STA 4105-1 may maintain one link (e.g., 2.4 GHz) to AP 110 and another link (e.g., 5 GHz) to STA 105-2 for peer-to-peer (P2P) communication.

As depicted, since STA 105-1 integrates multiple wireless technologies within a shared hardware environment, the device requires IDC management to efficiently allocate resources between Wi-Fi 115, Bluetooth 120, UWB 125, and Wi-Fi Direct 130. Without proper coordination, simultaneous transmissions across these radios may cause interference and degrade the overall network performance. To mitigate interference, STA 105-1 may receive assistance from AP 110 and STA 105-2 in managing wireless coexistence and reducing conflicts between different communication protocols.

To facilitate IDC mitigation, STA 105-1 may report unavailability windows to AP 110, informing it when the device 105-1 expects to allocate resources to another technology (e.g., pausing Wi-Fi transmission to prioritize Bluetooth). As mentioned above, if STA 105-1 sends these updates too frequently or excessively, it can lead to increased signaling overhead, which may cause network congestion and additional processing burden for AP 110.

To avoid such excessive signaling, AP 110 may predict the unavailability windows for STA 105-1, reducing and/or eliminating the IDC reporting. Further details about predicting unavailability windows are discussed below.

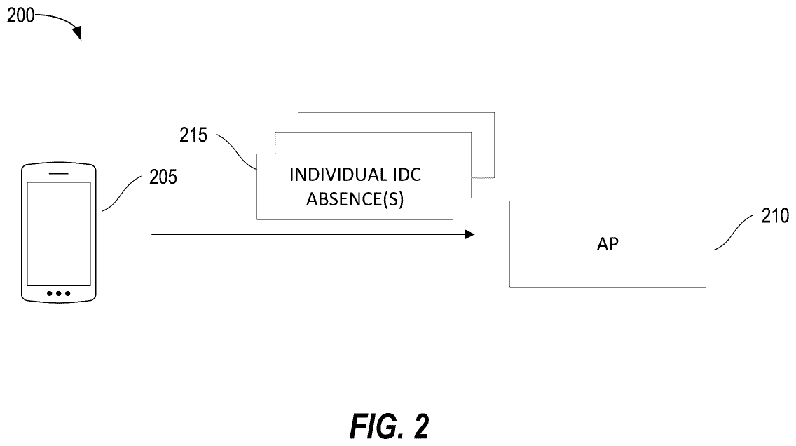

FIG. 2 depicts an example STA reporting an IDC unavailability frame to an associated AP, according to some embodiments of the present disclosure.

As depicted, STA 205 (which may correspond to STA 105-1 of FIG. 1) reports an unavailability window 215 to AP 210 (which may correspond to AP 110 of FIG. 1). The report may indicate the time period during which STA 205 expects to be unavailable for Wi-Fi communication due to allocating resources to another wireless technology (e.g., Bluetooth or UWB communication). The time period may be specified as either a start time and an end time or a start time with a duration. In cases where the end time is unknown, that field may be omitted and/or signaled as indefinite. STA 205 may use a control frame, a management frame, or a data frame to report its unavailability window to AP 210, such as a (Re)Association Request frame, an operating model notification (OMN) frame, or a specific frame designed for IDC unavailability reporting, and may include the Power Management field in the Frame Control field present in all frames. In some embodiments, “(Re)Association” and similar terms refers to both “association” as well as “re-association.” For example, a “(Re)Association Response frame” may refer to an “Association Response frame,” a “Re-Association Response frame,” or both. Similarly, in some aspects, “association” may refer to an initial association and/or a re-association.

The reported unavailability window may be based on various factors, including but not limited to, the expected Bluetooth/UWB/cellular activities, power management constraints, or scheduled tasks requiring a different radio interface. When any of these factors change, the relevant unavailability window may be updated. STA 205 may transmit another report to modify the originally reported time. However, when updates are sent too frequently (e.g., exceeding a defined limit), significant wireless congestion may result.

To prevent excessive unavailability reporting from overloading the network while still maintaining accurate unavailability reporting, AP 210 may predict a sequence of unavailability windows for STA 205. Further details on predicting unavailability windows are discussed below.

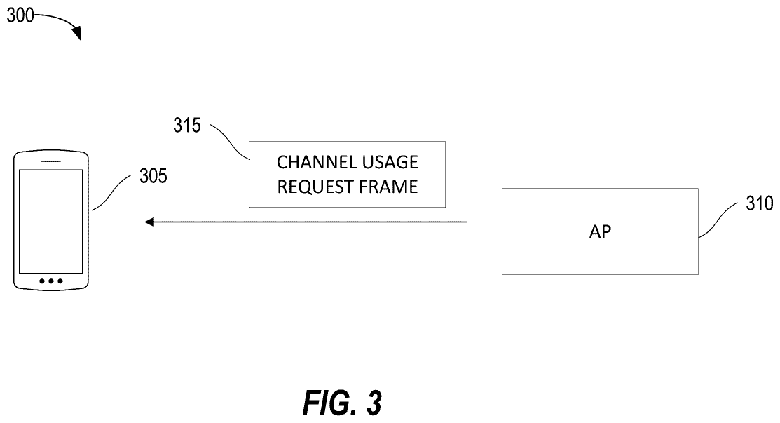

FIG. 3 depicts an example AP providing a predicted IDC unavailability pattern to a connected STA, according to some embodiments of the present disclosure.

As depicted, and subsequent to the unavailability reporting depicted in FIG. 2, AP 310 (which may correspond to AP 110 of FIG. 1 and AP 210 of FIG. 2) sends a channel usage request frame 315 to STA 305 (which may correspond to STA 105-1 of FIG. 1 and STA 205 of FIG. 2). The channel usage request frame 315 communicates a predicted unavailability sequence (the process for predicting the sequence is described in further detail below) to STA 305. The channel usage request frame 315 may contain a usage type (i.e., an unavailability indication) and a TWT element (i.e., to indicate the timing of the absences), among other elements. Since AP 310 sends the channel usage request frame to STA 305, STA 305 is not required to provide any information that may be compute-intensive to calculate or that the STA may deem private, and it no longer has to report the unavailability frames to AP 310. Once STA 305 receives the channel usage request frame 315, it may take a number of actions (or take no action at all), including providing an acknowledgement (e.g., that the channel usage request frame was received and/or a confirmation that the predicted unavailability sequence is correct) to AP 310 or an indication that the predicted unavailability sequence is incorrect, such as by explicit signaling or by implicit signaling (e.g., transmitting during a predicted unavailability window), in which case AP 310 may predict a new unavailability sequence and provide it to STA 305 via an updated channel usage request frame (or, if no unavailability sequence can be reliably predicted, send a teardown frame to the client). The STA 305 may also suspend transmission of unavailability reports that are already covered by the unavailability sequence provided by the AP 310.

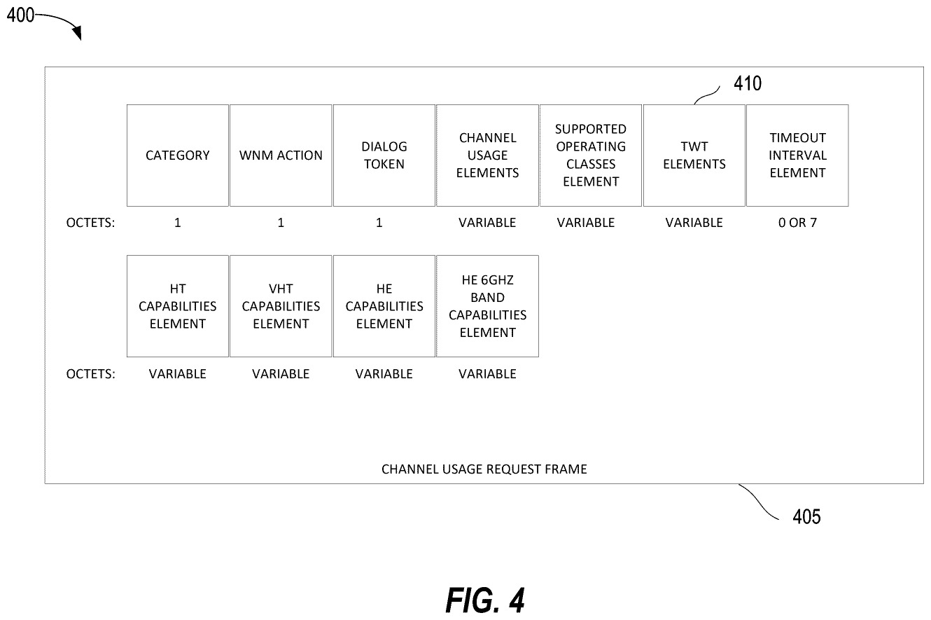

FIG. 4 depicts an example channel usage request frame, according to some embodiments of the present disclosure.

As depicted, channel usage request frame 405 (which may correspond to channel usage request frame 315 in FIG. 3) may contain a number of fixed fields and elements. The fields may include a category field, an action field, and a dialog token field. The elements may include channel usage elements, and a supported operating classes element. The category field may indicate that the frame relates to wireless network management. The action field may indicate an action associated with a wireless network manager (WNM), such as a channel usage request. The dialog token element may identify the transaction comprising the request frame and any follow-up frames such as a response frame. The channel usage elements may identify a request usage mode and optionally include spectrum information identified by a tuple (operating class, channel number, etc.).

The channel usage request frame 405 may also contain one or more other elements, such as a supported operating class element, timeout interval element, a high throughput (HT) capabilities element, a very high throughput (VHT) capabilities element, a high efficiency (HE) capabilities element, and an HE 6 GHz band capabilities element, which are permitted for certain feature variants of the channel usage feature.

Also contained in the channel usage request frame 405 are one or more TWT elements 410 each of which may include a first target wake time, a TWT wake interval mantissa, and a TWT wake interval exponent. In general, TWT allows an AP to manage activity in a Wi-Fi network, to minimize medium contention between STAs, and to reduce the required amount of time that an STA in power-save mode must be awake. This may be achieved, for instance, by allocating STAs to operate at non-overlapping times, and/or frequencies, and concentrate the frame exchanges in predefined service periods. An STA can either negotiate a TWT agreement with the AP, or it can be part of an AP-initiated TWT agreement.

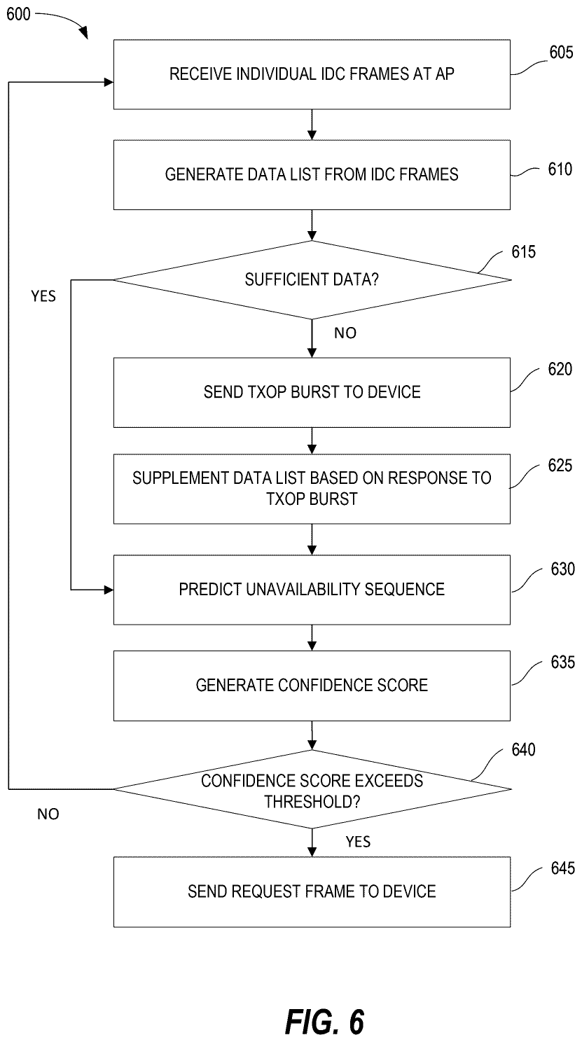

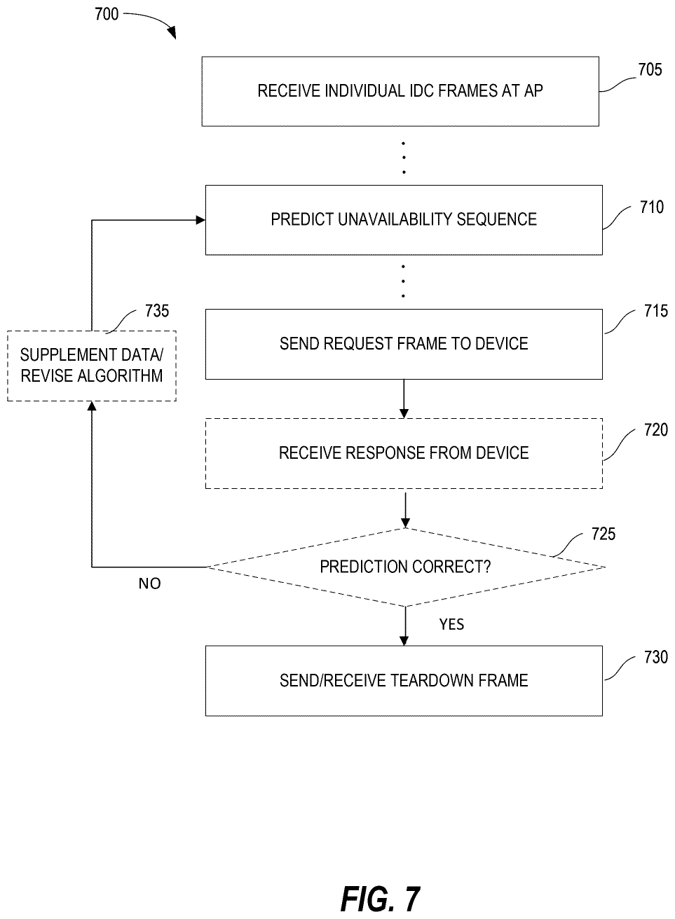

The channel usage request frame 405 may be provided by the AP to the STA to communicate the AP's predicted unavailability sequence for the STA as depicted with respect to FIG. 2. The unavailability sequence may be predicted based on one or more steps depicted with respect to FIGS. 6 and 7.

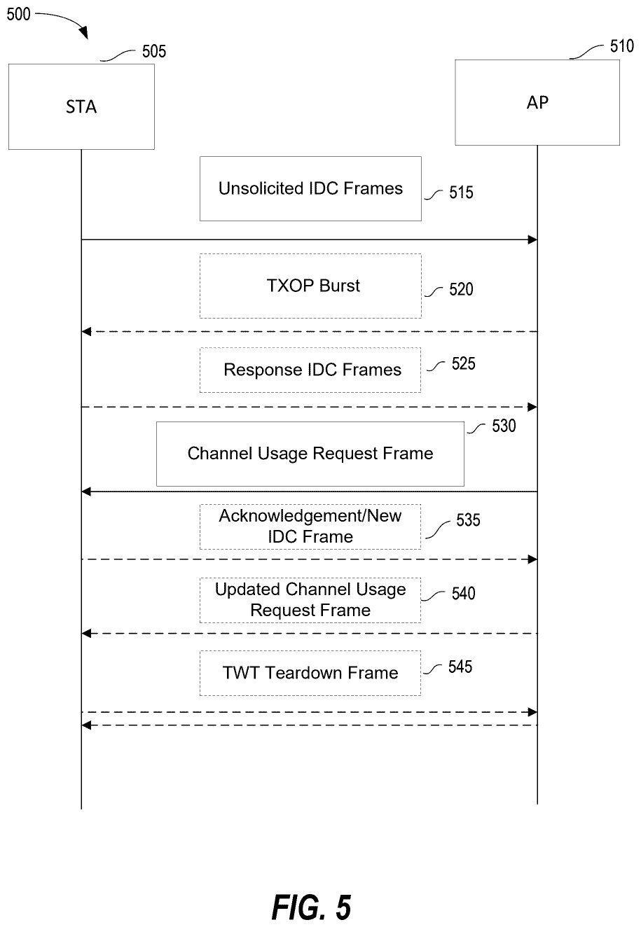

FIG. 5 depicts an example interaction in which the associated AP provides the predicted IDC unavailability pattern based on IDC frames associated with the connected STA, according to some embodiments of the present disclosure.

As depicted, the STA 505 (which may be a device in a peer to peer (P2P) connection) sends one or more unsolicited IDC unavailability frames to the AP 510. The STA 505 may be associated with the AP 510, and may integrate multiple wireless technologies (e.g., Wi-Fi, Bluetooth, UWB) in shared hardware resources. The unsolicited IDC unavailability frames 515 may be one-off control frames that a STA may send to indicate a window of unavailability without prompting from the associated AP. The IDC unavailability frames may include other frames, such as ones that include the Power Management field (which can also signal the start and/or end of an unavailability window). In general, IDC unavailability frames are used to manage the information exchange between a wireless client, such as a STA, and an AP, and may include, among others, request to send (RTS) frames, clear to send (CTS) frames, acknowledgment frames, PS poll frames, multi-STA block frames, and/or buffer status report poll (BSRP) trigger frames. The unsolicited IDC frames 515 may indicate the time period during which STA 505 expects to be unavailable for Wi-Fi communication due to having to allocate resources to another wireless technology (e.g., Bluetooth or UWB communication). The time period may be specified as either a start time and an end time or a start time with a duration. In some embodiments, the end time may be signaled via separate frames and/or by transmitting a frame. By proactively sending the IDC unavailability frames (i.e., before the unavailability begins), STA 505 provides the AP 510 necessary information to help prevent wireless interference and congestion.

In cases when the STA 505 reports few or no unsolicited IDC frames 515 (e.g., when an STA is in PM=1 mode), the AP 510 may prompt STA 505 to provide more information, such as by sending long (e.g. 2 milliseconds) and dense TXOP bursts 520 to the STA 505. In response, the STA 505 may send response IDC frames 525 to the AP 510 which provides more data points to the AP 510 for use in predicting an unavailability sequence for the STA 505. Like the unsolicited IDC frames 515, the response IDC frames 520 may indicate the time period during which STA 505 expects to be unavailable for communication, where the time period may be specified as either a start time and an end time or a start time with a duration.

Once the AP 510 has predicted the unavailability sequence with a certain level of confidence, it provides the predicted unavailability sequence to the STA 505 via a channel usage request frame 530. The channel usage request frame 530 may contain a number of elements, including one or more TWT elements, as depicted with respect to FIGS. 3 and 4. In some embodiments, the AP 510 may request for the STA 505 to cease sending unavailability messages for individual unavailability windows whenever the upcoming unavailability window is contained within the predicted periodicity pattern indicated in the request.

Upon receiving the channel usage request frame 530, STA 505 may take a number of actions, depicted as acknowledgement/new frame 535. For example, STA 505 could take no immediate action (in which case the AP 510 may operate in accordance with the predicted unavailability sequence, with the expectation that the client will cease sending individual notifications of an impending unavailability), could respond with an acknowledgment of the predicted availability sequence (in which case the AP 510 may also operate in accordance with the predicted unavailability sequence), or could respond with an indication that the predicted unavailability sequence is incorrect and/or not to be implemented. Such an indication could comprise the STA 505 sending a new IDC frame to the AP 510 that differs from the predicted unavailability sequence and/or transmit during a time in which the STA 505 should have been available to receive transmissions from the AP according to the predicted unavailability sequence (i.e., the STA 505 operates contradictory to the predicted unavailability sequence sent via the channel usage request frame 530). An incorrect predicted unavailability sequence may predict that the STA 505 is available to receive a transmission from the AP 510 when the STA 505 is actually unavailable and/or may predict that the STA 505 is unavailable to receive a transmission from the AP 510 when the STA 505 is actually available. Alternatively, the STA 505 may shift its operations to match the predicted unavailability sequence.

If the STA 505 implicitly (e.g., sending a contradictory transmission) or explicitly (e.g., sends a response) rejects the predicted unavailability sequence, the AP 510 may predict a new unavailability sequence according to one or more steps depicted with respect to FIGS. 6 and 7. The new predicted unavailability sequence may be provided in an updated channel usage request frame 540 to the STA 505. The updated channel usage request frame 540 may contain some or all of the elements contained in the channel usage request frame 530. Once the STA 505 accepts a predicted unavailability agreement (either implicitly by taking no action or explicitly by sending an acknowledgement), the STA 505 may cease sending IDC frames to the AP, reducing wireless congestion.

Finally, once the implementation of a successfully predicted unavailability sequence is completed (i.e., a P2P session ends), the STA 505 may teardown the TWT agreement (e.g., by sending a TWT teardown frame 545). Alternately, the AP 510 may send the TWT teardown frame 545. In some embodiments, the TWT teardown frame 545 may be based on new STA transmissions during a period the AP had predicted to be an unavailability window.

FIG. 6 depicts an example method for the associated AP to predict the IDC unavailability pattern and provide it to the connected STA, according to some embodiments of the present disclosure. In some embodiments, the method 600 may be performed by one or more network devices, such as AP 110 as depicted in FIG. 1, AP 210 as depicted in FIG. 2, AP 310 as depicted in FIG. 3, and AP 510 as depicted in FIG. 5.

At block 605, an AP (e.g., AP 110 of FIG. 1 or AP 510 of FIG. 5), receives one or more individual IDC unavailability frames (e.g., unsolicited IDC unavailability frames 515 of FIG. 5) from a connected STA (e.g., STA 105-1 in FIG. 1 or STA 505 of FIG. 5). The received IDC frames may explicitly indicate the time period during which a connected STA expects to be unavailable for communication (e.g., where the time period may be specified as either a start time and an end time or a start time with a duration) or implicitly indicate the time period via a “ready for business” frame.

At block 610, the AP generates a list of data points from the received IDC frames. The data points may correspond to a time at which the window of unavailability is to begin and/or a time at which the window of unavailability is to end (e.g., a start time, an end time, a start time coupled with a duration, and/or the like). At block 615, the AP determines whether the data extracted from the received IDC frames are sufficient to predict an unavailability sequence. For example, few or no data points is not sufficient for detecting a pattern and predicting future unavailability. If the data is sufficient, the method proceeds directly to block 630. If the data is not sufficient, the method 600 may wait until more data is gathered or move to block 620.

At block 620, the AP prompts the STA to provide additional unavailability information to the AP in order to bolster the list data points. For example, the AP may send a burst of long (e.g., 2 milliseconds) and dense TXOPs to the STA. The AP may quickly cancel each TXOP (i.e., so as to reuse the medium time for other connected STAs). In general, a TXOP is a bounded time interval in which stations are permitted to transfer a series of frames. As a result, it increases throughput and reduces delay of data frames via eliminating contention periods between transmissions. In response to the TXOP burst, the STA may send IDC frames to the AP (e.g., response IDC frames 525 of FIG. 5). At block 625, the AP supplements the list of data points by adding the corresponding start and/or end times from the new IDC frames to the list.

At block 630, the AP predicts, using an algorithm, an unavailability sequence for the STA. The predicting may comprise detecting a pattern of unavailability from the list of data points (i.e., the reported start and/or end times, or a common core interval within most of the reported unavailability windows) and then predicting future unavailability windows from the pattern. In some embodiments, the AP may utilize additional information while detecting the unavailability pattern. The algorithm may be provided patterns associated with wireless communication protocols. For example, a particular Bluetooth protocol may have a sequence of thirty millisecond unavailability periods with twenty millisecond availability periods, a particular UWB protocol may have a sequence of twenty-three millisecond unavailability periods with one hundred millisecond available periods, and a particular Wi-Fi protocol may have regular beacons of 0.5 milliseconds every 102.4 milliseconds. Additionally, the algorithm may adjust its operations to focus, for instance, on Bluetooth patterns if a Bluetooth signature is detected (e.g., by using a spectrum analysis tool which scans for and detects non-Wi-Fi radio interference on particular frequency bands). In some embodiments, the algorithm may be performed at the AP, or alternatively, in a networked computer, such as the cloud. The algorithm may also process multiple quality of service (QOS) flows occurring in parallel.

At block 635, the AP generates a confidence score associated with the predicted unavailability sequence. For example, the confidence score may be based on a number of periodic pulses in a row being aligned with a particular frequency. At block 640, the AP compares the confidence score to a threshold. The threshold may likewise be based on a number of periodic pulses in a row being aligned with a particular frequency, but may further be based on additional information, such as IDC type, known interferes, and/or detected IDC types. For example, the threshold may be set to four out of six periodic pulses in a row that are aligned at the frequency of a known interferer or IDC type but may be set to three out of six periodic pulses in a row aligned at the frequency of a known interferer or IDC type if the spectrum analysis tool also detected that particular interferer or IDC type. In another example, the threshold may be set to six out of eight periodic pulses in a row that are aligned at any frequency (i.e., the threshold is set higher if less additional information was identified during the prediction process). If the confidence score meets or exceeds the threshold (e.g., 4 or more out of 6 periodic pulses in a row are aligned at the frequency of a known interferer or IDC type), the method 600 moves directly to 645. If the confidence score does not meet or exceed the threshold, the method 600 moves back to block 605 to predict a new unavailability sequence that is then evaluated to determine if it meets or exceeds the confidence threshold. In some embodiments, the AP, prior to predicting the new unavailability sequence, may repeat one or more of steps 620 and 625 to gather more data for use in the new prediction.

At block 645, the AP sends the predicted unavailability sequence to the STA via a frame, such as a channel usage request frame (e.g., channel usage request frame 405 of FIG. 4). Subsequent to sending the frame, the AP and/or the STA may take a number of further actions as depicted with respect to FIG. 7.

FIG. 7 depicts an example method for the associated AP to provide a teardown frame and/or perform remedial action with respect to the predicted IDC availability pattern based on one or more responses from the connected STA, according to some embodiments of the present disclosure. In some embodiments, the method 700 may be performed by one or more network devices, such as AP 110 as depicted in FIG. 1, AP 210 as depicted in FIG. 2, AP 310 as depicted in FIG. 3, and AP 510 as depicted in FIG. 5, and/or STA 105-1 as depicted in FIG. 1, STA 205 as depicted in FIG. 2, STA 305 as depicted in FIG. 3, and STA 505 as depicted in FIG. 5.

Blocks 705, 710, and 715 may correspond to blocks 605, 630, and 645 in FIG. 6, respectively and are shown as a reference in method 700. One or more of blocks 705, 710, and 715 may also be performed by an associated AP during method 700. As depicted with respect to FIG. 6, the AP predicts an unavailability sequence, such as based on IDC frames received from a connected STA, and sends the predicted unavailability sequence via a channel usage request frame to the STA (e.g., channel usage request frame 405 of FIG. 4).

Once the STA receives the channel usage request frame, it may take one or more actions, or take no action at all. If the STA takes no immediate action, the AP may treat that as an acknowledgment of the predicted unavailability sequence and/or operate according to the predicted unavailability sequence (e.g., transmit during predicted windows of availability, not transmit during predicted windows of unavailability, and/or the like). The STA may also send a response to the AP, such as at block 720, acknowledging the predicted unavailability sequence and/or confirm its accuracy. In that case, the AP may likewise operate according to the precited unavailability sequence. In both cases, the STA no longer has to send individual IDC frames to the AP (i.e., when an unavailability window begins and/or ends), saving wireless medium space and time.

Alternatively, the STA may send a response to the AP with an indication that the predicted unavailability sequence is incorrect. Similarly, it may indicate an incorrect predicted unavailability sequence by operating contradictory to such sequence (e.g., communicate via Bluetooth with another STA during a period predicted by the AP to be available). In these cases, when the prediction is incorrect, as determined at block 725, the AP may predict a new unavailability sequence at block 710 (e.g. block 630 of FIG. 6) according to one or more steps described with respect to FIG. 6. Additionally, prior to predicting a new availability sequence, the AP may supplement the list of data used in the prediction and/or adjust the algorithm at block 735 to provide an improved unavailability sequence. In some embodiments, block 735 may correspond to blocks 615, 620, and 625 of FIG. 6, among others. If the AP is unable to predict a new unavailability sequence with the requisite level of confidence, the AP may teardown any existing unavailability sequence.

Once a particular session ends (e.g., P2P communication between connected STAs is terminated and the predicted unavailability window may longer be utilized), the STA or the AP may terminate the agreement, such as by sending a teardown frame. For example, the teardown frame may be a TWT teardown frame with a negotiation type subfield set to zero and a TWT flow identifier field set to the value of the corresponding TWT flow identifier.

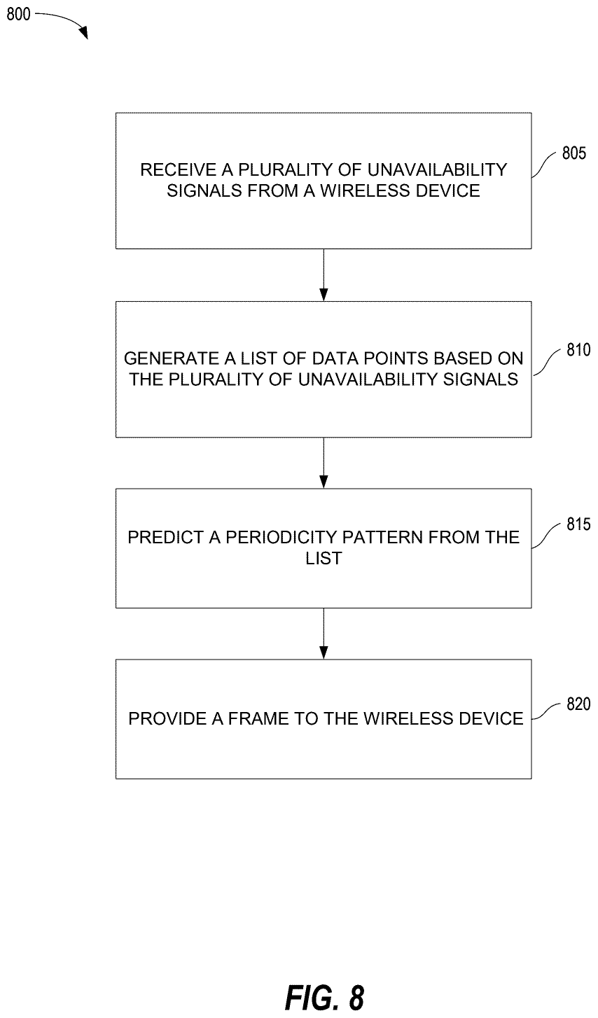

FIG. 8 is a flow diagram depicting an example method 800 for IDC unavailability prediction, according to some embodiments of the present disclosure.

At block 805, the AP (e.g., AP 110 of FIG. 1 or AP 510 of FIG. 5) receives a plurality of unavailability signals (e.g., unsolicited IDC frames 515 of FIG. 5) from a wireless device (e.g., STA 105-1 in FIG. 1 or STA 505 of FIG. 5), such as a client device. In some embodiments, such as when the AP receives few or no availability signals, the AP may wait to receive more data or send one or more transmissions to the wireless device (e.g., a TXOP burst) to retrieve additional information (e.g., response IDC frames). The IDC frames may indicate the time period during which the wireless device expects to be unavailable for communication.

At block 810, the AP generates a list of data points based on the plurality of unavailability signals as discussed at block 610 of FIG. 6. In some embodiments, the list of data points may correspond to a time at which the window of unavailability is to begin, a time at which the window of unavailability is to end, a duration of the window of unavailability (e.g., coupled with a start time), and/or another indication informing the AP the window of unavailability has ended (e.g., a transmission from the STA).

At block 815, the AP determines a periodicity pattern from the list of data points. For example, the determining may comprise detecting a pattern of unavailability from the list of data points (i.e., the reported start and/or end times) and then predicting future unavailability windows from the pattern as discussed at block 630 of FIG. 6. In some embodiments, the determining may comprise evaluating a type of transmission or one or more transmission patterns associated with the type of transmission (e.g., identifying a particular wireless communication protocol and an availability sequence associated with that particular wireless communication protocol).

At block 820, the AP provides a frame comprising details associated with the periodicity pattern to the wireless device. In some embodiments, the details comprise one or more target wake time elements sent via a channel usage request frame (e.g., channel usage request frame 405 of FIG. 4).

In some embodiments, the AP may receive a response from the wireless device (e.g., in response to the channel usage request frame provided to the wireless device from the AP) and perform an action based on the response, such as determining a new periodicity pattern and providing an updated request frame to the wireless device as discussed at blocks 720-735 of FIG. 7. The response from the client device may comprise an acknowledgment and/or a new IDC frame, among others.

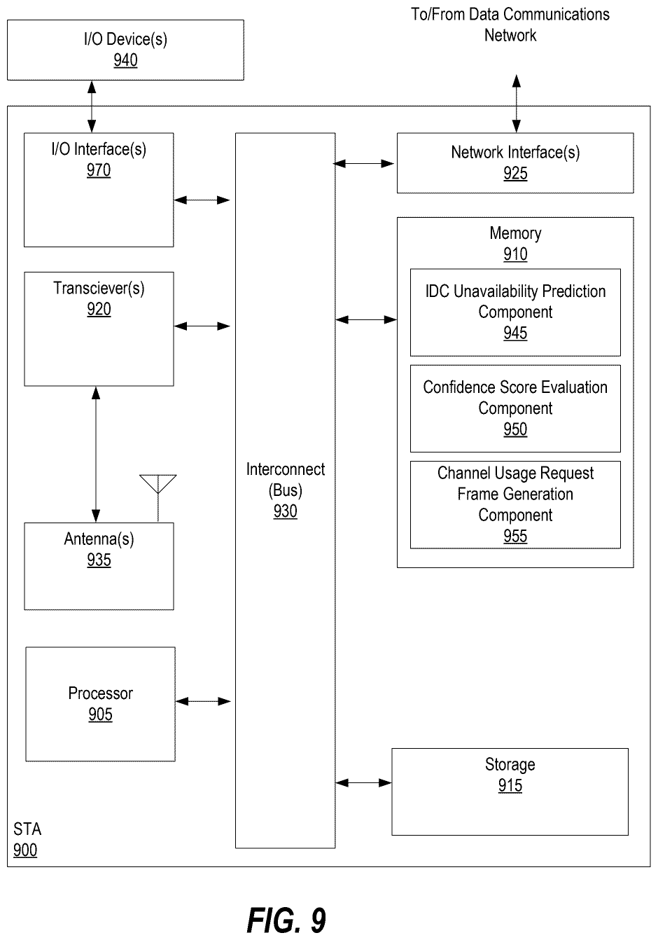

FIG. 9 depicts an example network device 900 configured to perform various aspects of the present disclosure. In some embodiments, the example network device 900 may be an AP or an STA, and communicate with and/or provide support for an associated STA (e.g., which is a device that operates multiple wireless technologies on shared hardware).

As illustrated, the example network device 900 includes a processor 905, memory 910, storage 915, one or more transceivers 920, one or more I/O interfaces 970, and one or more network interfaces 925. In some embodiments, I/O devices 940 are connected via the I/O interface(s) 970. Further, via the network interface 925, the network device 900 can be communicatively coupled with one or more other devices and components (e.g., via a network, which may include the Internet, local network(s), and the like). Each of the components is communicatively coupled by one or more buses 930. In some embodiments, one or more antennas 935 may be coupled to the transceivers 920 for transmitting and receiving wireless signals.

The processor 905 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 905 processes information received through the transceiver 920, I/O interfaces 970, and the network interfaces 925. The processor 905 retrieves and executes programming instructions stored in memory 910, as well as stores and retrieves application data residing in storage 915.

The storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 915 may store a variety of data for the efficient functioning of the system.

The memory 910 may include random access memory (RAM) and read-only memory (ROM). The memory 910 may store processor-executable software code containing instructions that, when executed by the processor 905, enable the network device 900 to perform various functions described herein for wireless communication. In the illustrated example, the memory 910 includes three software components: the IDC unavailability prediction component 945, the confidence score evaluation component 950, and the channel usage request frame generation component 955.

In one embodiment, the IDC unavailability prediction component 945 may manage IDC unavailability frames received from a client device, generate a corresponding list of data points, and predict a periodicity pattern from the list, among others. The IDC unavailability prediction component 945 may also instruct the access point to retrieve more data from the client device.

In one embodiment, the confidence score evaluation component 950 may generate a confidence score associated with the periodicity pattern and compare the confidence score to a threshold value to determine if the prediction meets an expected level of precision before providing to the client device (and if not, may instruct the access point to create a new prediction).

In one embodiment, the channel usage request frame generation component 955 may generate a frame with the IDC unavailability prediction (e.g., a channel usage request frame with TWT elements). The channel usage request frame generation component 955 may also send the frame to the client device, receive a response from the client device, and/or send an updated frame when prompted.

To facilitate understanding, identical reference numerals have been used, where possible, to designate identical elements that are common to the figures. It is contemplated that elements disclosed in one embodiment may be beneficially used in other embodiments without specific recitation.

Although depicted as a discrete component for conceptual clarity, in some embodiments, the operations of the depicted components (and others not illustrated) may be combined or distributed across any number of components. Further, although depicted as software residing in memory 910, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving a plurality of unavailability signals from a wireless device;
generating a list of data points based on the plurality of unavailability signals;
predicting a periodicity pattern from the list; and
providing a frame comprising details associated with the periodicity pattern to the wireless device.

2. The method of claim 1, wherein the receiving the plurality of unavailability signals from the wireless device further comprises sending one or more transmissions to the wireless device to retrieve additional information associated with the list of data points.

3. The method of claim 1, wherein the wireless device comprises a client device and wherein the generating the list of data points based on the plurality of unavailability signals and predicting the periodicity pattern from the list are performed by an access point.

4. The method of claim 1, wherein the details associated with the periodicity pattern comprise one or more target wake time elements.

5. The method of claim 1, further comprising receiving a response from the wireless device and performing an action based on the response, wherein the performing of the action comprises determining a new periodicity pattern and providing an updated frame to the wireless device.

6. The method of claim 1, wherein the list of data points comprises at least one of:
one or more unavailability start times; or
one or more unavailability end times; or
one or more unavailability durations.

7. The method of claim 1, wherein the predicting the periodicity pattern from the list comprises evaluating at least one of:
a type of transmission; or
one or more transmission patterns associated with the type of transmission.

8. The method of claim 1, wherein the predicting the periodicity pattern from the list further comprises generating a confidence score based on information associated with the list and determining that the confidence score exceeds a threshold value.

9. An access point, comprising:
one or more processors; and
one or more memories storing a program, which, when executed on any combination of the one or more processors, performs operations, the operations comprising:
receiving a plurality of unavailability signals from a wireless device;
generating a list of data points based on the plurality of unavailability signals;
predicting a periodicity pattern from the list; and
providing a frame comprising details associated with the periodicity pattern to the wireless device.

10. The access point of claim 9, wherein the receiving the plurality of unavailability signals from the wireless device further comprises sending one or more transmissions to the wireless device to retrieve additional information associated with the list of data points.

11. The access point of claim 9, wherein the wireless device comprises a client device and wherein the generating the list of data points based on the plurality of unavailability signals and determining the periodicity pattern from the list are performed by an access point.

12. The access point of claim 9, wherein the details associated with the periodicity pattern comprise one or more target wake time elements.

13. The access point of claim 9, further comprising receiving a response from the wireless device and performing an action based on the response, wherein the performing of the action comprises determining a new periodicity pattern and providing an updated frame to the wireless device.

14. The access point of claim 9, wherein the list of data points comprises at least one of:
one or more unavailability start times; or
one or more unavailability end times; or
one or more unavailability durations.

15. The access point of claim 9, wherein the predicting the periodicity pattern from the list comprises evaluating at least one of:
a type of transmission; or
one or more transmission patterns associated with the type of transmission.

16. A non-transitory computer-readable medium containing computer program code that, when executed by operation of one or more computer processors, performs operations comprising:
receiving a plurality of unavailability signals from a wireless device;
generating a list of data points based on the plurality of unavailability signals;
predicting a periodicity pattern from the list; and
providing a frame comprising details associated with the periodicity pattern to the wireless device.

17. The non-transitory computer-readable medium of claim 16, wherein the receiving the plurality of unavailability signals from the wireless device further comprises sending one or more transmissions to the wireless device to retrieve additional information associated with the list of data points.

18. The non-transitory computer-readable medium of claim 16, wherein the wireless device comprises a client device and wherein the generating the list of data points based on the plurality of unavailability signals and predicting the periodicity pattern from the list are performed by an access point.

19. The non-transitory computer-readable medium of claim 16, wherein the details associated with the periodicity pattern comprise one or more target wake time elements.

20. The non-transitory computer-readable medium of claim 16, further comprising receiving a response from the wireless device and performing an action based on the response, wherein the performing of the action comprises determining a new periodicity pattern and providing an updated frame to the wireless device.
